(19) United States
(12) Patent Application Publication
(10) Pub. No.: US 2014/0276268 A1
(43) Pub. Date: Sep. 18, 2014

(54) METHODS FOR PERFORMING OCCULAR EXERCISES AND DEVICES THEREOF

(71) Applicant: Kevin Paffett, Penfield, NY (US)

(72) Inventor: Kevin Paffett, Penfield, NY (US)

(21) Appl. No.: 14/216,953

(22) Filed: Mar. 17, 2014

Related U.S. Application Data
(60) Provisional application No. 61/798,763, filed on Mar. 15, 2013.

(51) Int. Cl. A61H 5/00

(52) U.S. Cl. CPC A61H 5/00
USPC 601/37

(57) ABSTRACT

A method for facilitating performance of ocular exercises includes providing an ocular exercise eyewear comprising one or more focusing elements, the one or more focusing elements positioned on the ocular exercise eyewear to guide a wearer's vision to a location at or near a perimeter of the wearer's field of vision. Instructions are provided directing the wearer's vision to the one or more focusing elements to perform an ocular range of motion exercise. An ocular exercise apparatus and a method of making the ocular exercise apparatus are also disclosed.

This application claims the benefit of U.S. Provisional Patent Application Ser. No. 61/798,763, filed Mar. 15, 2013, which is hereby incorporated by reference in its entirety.

### FIELD

This invention generally relates to methods and devices for guiding a wearer in performing ocular exercises and, more specifically, to methods and devices for guiding a wearer to perform ocular stretches within a focused range of motion.

### BACKGROUND

Eye exercises are known to have several benefits including strengthening the muscles around the eyes which improves eye performance, as well as increasing blood circulation and stimulating nerves around the eyes which provides therapeutic effects. Current devices for facilitating performance of ocular exercises include flashing lights or electronic signals that the user tracks in order to perform the exercises. These devices are often complex in design and further require the users to maintain their eyes in an open position during the exercises.

Eye exercises may, in particular, be utilized to obtain headache relief. The use of lights, and specifically flashing lights, may further exacerbate a headache sufferer's symptoms. Further, tracking an object with the eyes open provides a less efficient method of exercising the eyes.

Other available techniques for dealing with headaches, such as migraine headaches, cluster headaches, and tension headaches are similarly problematic. Current techniques for dealing with the different types of headaches are typically complex, expensive, invasive, and in many cases ineffective. For example, drug therapies or surgical interventions may be utilized but are invasive, which may not be desirable in some cases.

### SUMMARY

A method for facilitating performance of ocular exercises includes providing an ocular exercise eyewear comprising one or more focusing elements, the one or more focusing elements positioned on the ocular exercise eyewear to guide a wearer's vision to a location at or near a perimeter of the wearer's field of vision. Instructions are provided directing the wearer's vision to the one or more focusing elements to perform an ocular range of motion exercise.

A method of making an optical exercise apparatus comprises providing a frame configured to be worn on a wearer's head. A lens is attached to the frame to the frame. One or more focusing elements are provided for focusing a wearer's vision disposed on at least one of the lens or the frame, wherein the focusing elements are positioned to focus the wearer's vision to a location at an edge of the wearer's peripheral vision when the frame is worn on the wearer's head.

An ocular exercise apparatus comprises a frame configured to be worn on a wearer's head. A lens is supported by the frame. One or more focusing elements for focusing a wearer's vision are disposed on at least one of the lens or the frame, wherein the focusing elements are positioned to focus the wearer's vision to a location at an edge of the wearer's peripheral vision when the frame is worn on the wearer's head.

### BRIEF DESCRIPTION OF THE DRAWINGS

FIG. 1 is a perspective view of an ocular exercise apparatus of the present invention.

FIG. 2 is a perspective view of another embodiment of an ocular exercise apparatus of the present invention.

FIG. 3 is a flow chart for a method of performing ocular exercises.

FIGS. 4A-4F are perspective phantom views of an ocular exercise apparatus of the present invention illustrating the eye positions of the wearer while performing the method as illustrated in FIG. 3.

FIG. 5 is a flow chart of a method of providing instructions for performing ocular exercises.

### DETAILED DESCRIPTION

An exemplary ocular exercise apparatus 10 is illustrated in FIGS. 1-2. The ocular exercise apparatus 10 includes a frame 12, a lens 14, and one or more focusing elements 16(1), 16(2), although the ocular exercise apparatus 10 may include other elements and components in other configurations. This technology provides a number of advantages including methods and devices that facilitate focused range of motion ocular exercises. The known benefits of rapid eye movement (REM) suggest that ocular exercises performed while the eye is closed may be more effective. The device and methods advantageously direct the wearer's eyes to a desired position to perform an ocular exercise, and instruct the wearer to perform optical stretching exercises, focused at a particular range of motion for the wearer's eyes while, if desired, maintaining the eyes in a closed position.

Referring more specifically to FIGS. 1-2, the ocular exercise apparatus 10 is in the form of wrap-around sunglasses, although other shapes and configurations corresponding to other types of eyewear such as eyeglasses, sunglasses, safety glasses, goggles, an eye patch, or an eyemask may be utilized as the ocular exercise apparatus 10.

The frame 12 is designed to permit a user to wear the ocular exercise apparatus 10 and may, by way of example only, be a standard eyeglass or sunglass frame, although other configurations may used, such as a material that wraps around the wearer's head as used in a typical eye mask or goggles. The frame 12 may be formed from any solid material, such as metals or plastics by way of example only, although malleable materials, such as various fabrics or elastic materials by way of example, may also be used to form the frame 12. The frame 12 may be a standard size, custom-sized for the individual wearer, or adjustable in order to fit the individual wearer, for example. The frame 12 is configured to provide support for lens 14.

The lens 14 may be a standard eyeglass or sunglass lens formed of standard materials for such eyewear such as various plastics, for example. The lens 14 is configured to fit closely to the wearer's face such that the lens covers nearly the entire field of vision of the wearer, although the lens 14 may be formed in various shapes and sizes which may depend on the type of the frame 12 used to support the lens 14. In this example, the lens 14 is opaque, although the lens 14 may have other optical properties, such as tint, color, translucency, transparency, or mirrored. The lens 14 may additionally have a coating to provide additional effects, such as tinting by way of example.

The lens 14 includes one or more focusing elements 16(1), 16(2), although in other examples the one or more focusing elements 16(1), 16(2) may be located on the frame 12 and other types and/or numbers of elements may be used. The focusing elements 16(1), 16(2) are positioned on the outer edges of the lens 14 to serve as a guidepost to guide the eyes of a user who is wearing the ocular exercise apparatus 10 to the edge of the user's peripheral vision at or near the perimeter of the user's field of vision or the user's ocular range of motion, although the focusing elements 16(1), 16(2) may be located in other positions on the lens 14. In this configuration, the focusing elements 16(1), 16(2) are suited to assist the user in exploring the potential range of motion of the user's eyes. The focusing elements 16(1), 16(2) may be located at standard locations on the lens 14 for a one size fits all approach or may alternatively be custom located for an individual user based on the user's physiological characteristics or peripheral vision, for example. The number of focusing elements 16(1), 16(2) on the lens 14 may be varied, although in one example the lens 14 includes at least four or more focusing elements 16(1), 16(2).

Focusing elements 16(1), 16(2) are located at the edge of the user's peripheral vision, regardless of the position of the user's eyes in the field of gaze, and are configured to guide the user's vision to the outer edge of the user's field of vision at or near the perimeter of the user's field of vision. Referring to FIG. 1, the ocular exercise device 10 is shown with focusing elements 16(1), which comprise apertures or slits in the opaque lens 14, although the focusing elements 16(1) could have other configurations, such as pinholes by way of example. To compensate for slight variations in the size and shape of the wearer's field of vision, the focusing elements 16(1) are sized to occupy an area on the lens 14 greater than about two square millimeters, although the focusing elements 16(1) may be configured in different sizes. The focusing elements 16(1) are configured as isolated areas in the lens 14 that contrast in appearance with their immediate surroundings on the eyewear. The focusing elements 16(1) may be cut or molded directly into the lens 14, such that the apertures or slits form an area of absence in the lens 14 itself. In another example, the focusing elements 16(1) are etchings formed in the lens 14. The etchings may be any shape and size configured to guide the user's eye to the focusing element 16(1). The focusing elements 16(1) are configured so they may be easily focused on and through by the wearer. In another example, focusing elements 16(1) may be transparent sections or areas of absence of tinting coating in a tinted lens, or may comprise a tinted or colored section on an otherwise transparent lens 14. Focusing elements 16(1) for this example may have various shapes and sizes.

Referring to FIG. 2 another example of the ocular exercise apparatus 10 with focusing elements 16(2) is illustrated. In this example, focusing elements 16(2) comprise protrusions from the inner surface of the lens 14 that are positioned to contact the user's face while the user is wearing the ocular exercise apparatus 10. The focusing elements 16(2) are located on the edge of the lens 14 to direct the user's vision to the outer edge of the field of vision and/or ocular range of motion by the tactile sensation, although the focusing elements 16(2) could be located in other locations such as on the frame 12 by way of example. This example allows the user's vision to be positioned in the direction of the focusing element while maintaining the eyes in a closed position. The protrusions may be any size and shape suitable to provide a tactile sensation on the user's skin while the user is wearing the ocular exercise apparatus 10, although the protrusions could be custom sized to provide the function for an individual user.

The focusing elements 16(2) of FIG. 2 may be formed of any suitable material, such as plastics, rubbers, metal, Styrofoam, although other suitable materials may also be used. In one example, the focusing elements 16(2) may be removably attached to the lens 14 by any suitable means such as by a screw fit, friction fitting, magnetic attachment, hook and loop, a sticky polymer, or adhesive, although other suitable attachment means may be used. In one example, the focusing element 16(2) may be adjusted for fit, for example, by the use of a spring or a screw mechanism, although other adjustment mechanisms may also be used.

An exemplary method 300 for performing ocular exercises utilizing the ocular exercise apparatus 10 will now be described with reference to FIGS. 1-3. In step 302, the user positions the ocular exercise apparatus 10 on the user's face such that the lens 14 is positioned in front of the user's eyes. In one example, the ocular exercise apparatus 10 may be custom-fitted for the particular user.

In step 304, the user directs her eyes toward one of the focusing elements 16(1), 16(2) to the edge of the peripheral range of motion for the user's eyes. The user may utilize her vision to direct her eyes toward the focusing element 16(1), 16(2), although other methods, such as a tactile sensation on the user's face, may be used to direct the user's eyes to the edge of the range of peripheral motion in the direction of the focusing element 16(1), 16(2). In step 306, if the user directed her eyes toward the focusing element 16(1), 16(2), the user closes her eyes, although the user's eyes may be previously closed in an embodiment where the user's eyes were directed toward the focusing element 16(1), 16(2) by a tactile sensation. Further in step 306 the user maintains the position of the eyes obtained by directing the eyes toward the edge of the user's peripheral vision in the direction of the focusing element 16(1), 16(2). The user may maintain the position of the eye for a set period of time, for example, 5-25 seconds, although the user may maintain the position of the eye until the user obtains a desired result, such as relief from the tension, stress, or pain of a headache.

In step 308, the user determines whether to continue the exercise process. If in step 308, the user decides to continue, the method is repeated from step 304. The user may repeat the process for each of the focusing elements 16(1), 16(2), or may do multiple stretches at each of the focusing elements 16(1), 16(2), for example. If in step 308, the user decides to stop, for example if the user has obtained the desired result, such as relief of a headache, then the method ends at step 310.

The method of utilizing the ocular exercise apparatus 10 may be performed for various purposes including headache relief, to improve vision skills such as eye movement and control, to increase the range of eye motion, to simulate REM sleep patterns, or to stimulate eye movement for patients with diseases such as amblyopia, including strabismus amblyopia, although other uses for the ocular exercise method described may be contemplated. It is further contemplated the ocular exercise apparatus of the present invention may be utilized in medical testing of the eyes. By way of example, an eye tracking camera may be coupled to the lens 14 in order to observe and record the ocular exercises for medical testing purposes.

Referring to FIGS. 4A-4F, a lens 14 is illustrated along with the position of the user's eyes while focusing at each one of the focusing elements 16, respectively. The user may look at and through the focusing elements 16 in order to exercise the user's eyes. The focusing elements 16 direct the user's eyes to the edge of the user's peripheral vision to provide focused stretching of the extraocular muscles.

Referring now to FIG. 5, an exemplary method 500 of guiding a user to perform ocular exercises in accordance with the present invention will be described. In step 502, an ocular exercise apparatus 10 is provided to the user. In step 504, instructions are provided to the user to direct her eyes to the edge of her peripheral vision in the direction toward one of the focusing elements 16 while wearing the ocular exercise apparatus 10. The user's eyes may be directed toward the focusing element by the user's vision or by a tactile sensation on the user's face. In step 506, instructions are provided to the user to maintain the position obtained in step 504 while maintaining her eyes in a closed position for a set period of time or until relief from the headache symptoms is obtained. In one example, the user's eyes may already be closed if the user's eyes were directed toward the focusing element by a tactile sensation. The instructions may further indicate that the user may repeat the process as necessary to achieve the desired results.

With this technology, a user can be guided in performing ocular exercises while maintaining the eye(s) in a closed position. By this technology, relief can be obtained from headaches or other neurological disorders, such as neuralgia, as well as stress, strain, pressure, tension, fatigue, or pain due to eye overexertion. Advantageously, overall eye function can be improved and/or tear production can be induced.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A method for facilitating performance of ocular exercises, the method comprising:
providing an ocular exercise eyewear comprising one or more focusing elements, the one or more focusing elements positioned on the ocular exercise eyewear to guide a wearer's vision to a location at or near a perimeter of the wearer's field of vision; and
providing instructions directing the wearer's vision to the one or more focusing elements to perform an ocular range of motion exercise.

2. The method of claim 1 wherein the ocular exercise eyewear comprises a lens attached to a frame, the one or more focusing elements disposed on the lens or the frame.

3. The method of claim 1 wherein providing the instructions to the wearer comprises:
providing an instruction to direct the wearer's eyes to a position focused at one of the one or more focusing elements; and
providing an instruction to the wearer to maintain the position of the eyes focused at the one focusing element.

4. The method of claim 3 further comprising providing an instruction to the wearer to close the wearer's eye lids.

5. The method of claim 4 wherein the providing an instruction to the wearer to close the wearer's eye lids further comprises providing an instruction to maintain the position for at least 5 seconds.

6. The method of claim 4 wherein the providing an instruction to the wearer to close the wearer's eye lids further comprises providing an instruction to maintain the position for at least 20 seconds.

7. The method of claim 1 further comprising:
providing an instruction to the wearer to repeat until a desired effect is achieved.

8. A method of making an optical exercise apparatus comprising:
providing a frame configured to be worn on a wearer's head;
attaching a lens to the frame; and
providing one or more focusing elements for focusing a wearer's vision disposed on at least one of the lens or the frame, wherein the focusing elements are positioned to focus the wearer's vision to a location at an edge of the user's peripheral vision when the frame is worn on the wearer's head.

9. The method of claim 8 wherein the focusing elements comprise apertures cut directly into the lens.

10. The method of claim 8 wherein the focusing elements are etchings in the lens.

11. The method of claim 8 wherein the lens includes a coating on the surface of the lens.

12. The method of claim 11 wherein the focusing elements comprise an area of absence in the lens coating.

13. The method of claim 8 wherein the lens is transparent the focusing elements comprise markings on the transparent lens.

14. The method of claim 8 wherein four or more focusing elements are provided.

15. The method of claim 8 wherein the lens is one of tinted, mirrored, opaque, transparent, or translucent.

16. The method of claim 8 wherein the focusing elements comprise a protrusion extending from an inner surface of the lens or the frame.

17. The method of claim 8 wherein the focusing elements are removably attached to the inner surface of the lens or the frame.

18. An ocular exercise apparatus comprising:
a frame configured to be worn on a wearer's head;
a lens supported by the frame;
one or more focusing elements for focusing a wearer's vision disposed on at least one of the lens or the frame, wherein the focusing elements are positioned to focus the wearer's vision to a location at an edge of the user's peripheral vision when the frame is worn on the wearer's head.

19. The ocular exercise apparatus of claim 18 wherein the focusing elements comprise apertures cut directly into the lens.

20. The ocular exercise apparatus of claim 18 wherein the focusing elements are etchings in the lens.

21. The ocular exercise apparatus of claim 18 wherein the lens includes a coating on the surface of the lens.

22. The ocular exercise apparatus 21 wherein the focusing elements comprise an area of absence in the lens coating.

23. The ocular exercise apparatus of claim 18 wherein the lens is transparent and the focusing elements comprise markings on the transparent lens.

24. The ocular exercise apparatus of claim 18 comprising four or more focusing elements.

25. The ocular exercise apparatus of claim 18 wherein the lens is one of tinted, mirrored, opaque, transparent, or translucent.

26. The ocular exercise apparatus of claim 18 wherein the focusing elements comprise a protrusion extending from an inner surface of the lens or the frame.

27. The ocular exercise apparatus of claim 26 wherein the focusing elements are removably attached to the inner surface of the lens or the frame.
